(19) United States
(12) Patent Application Publication
(10) Pub. No.: US 2018/0160651 A1
(43) Pub. Date: Jun. 14, 2018

(54) Canine Saddlebag and Rain Gear Assembly

(71) Applicant: Michelle Holt, Bluebell, PA (US)

(72) Inventor: Michelle Holt, Bluebell, PA (US)

(21) Appl. No.: 15/375,977

(22) Filed: Dec. 12, 2016

(51) Int. Cl. A01K 13/00

(52) U.S. Cl. CPC A01K 13/006

(57) ABSTRACT

A canine saddlebag and rain gear assembly for stowing items and deploying rain gear includes a first panel that is configured to position over front shoulders of a dog and to couple to front legs of the dog. A plurality of second panels is coupled to the first panel and defines a plurality of pockets. A third panel is reversibly couplable to a front edge of the first panel. A hole is positioned in the third panel and is configured to insert a head of the dog such that the third panel is positioned over a chest of the dog. A sleeve is coupled to the third panel proximate to the hole. A hat is positioned in the sleeve and is reversibly extendable from the sleeve. The hat is configured to cover the head of the dog. The pockets are configured to stow items.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to canine saddlebag assemblies and more particularly pertains to a new canine saddlebag assembly for stowing items and deploying rain gear.

### BRIEF SUMMARY OF THE INVENTION

An embodiment of the disclosure meets the needs presented above by generally comprising a first panel that is configured to position over front shoulders of a dog and to couple to front legs of the dog. A plurality of second panels is coupled to the first panel and defines a plurality of pockets. A third panel is reversibly couplable to a front edge of the first panel. A hole is positioned in the third panel and is configured to insert a head of the dog such that the third panel is positioned over a chest of the dog. A sleeve is coupled to the third panel proximate to the hole. A hat is positioned in the sleeve and is reversibly extendable from the sleeve. The hat is configured to cover the head of the dog. The pockets are configured to stow items.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a canine saddlebag and rain gear assembly according to an embodiment of the disclosure.

FIG. 2 is a bottom view of an embodiment of the disclosure.

FIG. 3 is a top view of an embodiment of the disclosure.

FIG. 4 is an in-use view of an embodiment of the disclosure.

FIG. 5 is an in-use view of an embodiment of the disclosure.

FIG. 6 is an in-use view of an embodiment of the disclosure.

FIG. 7 is an in-use view of an embodiment of the disclosure.

### DETAILED DESCRIPTION OF THE INVENTION

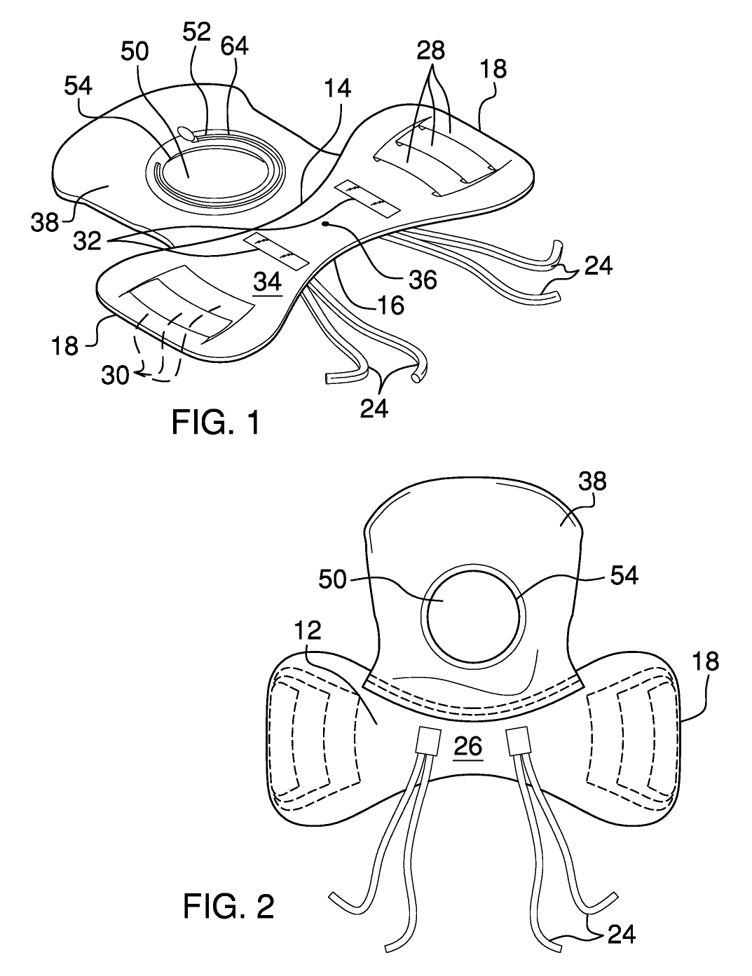

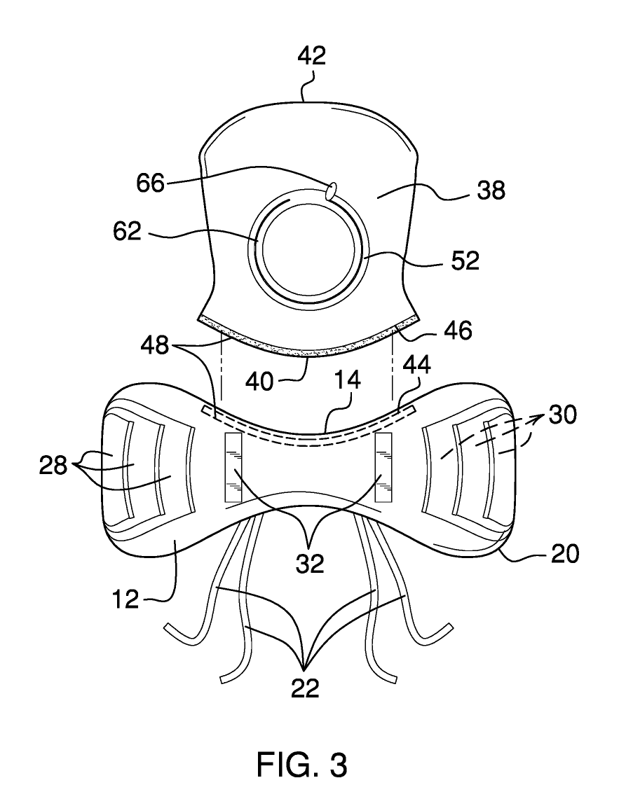

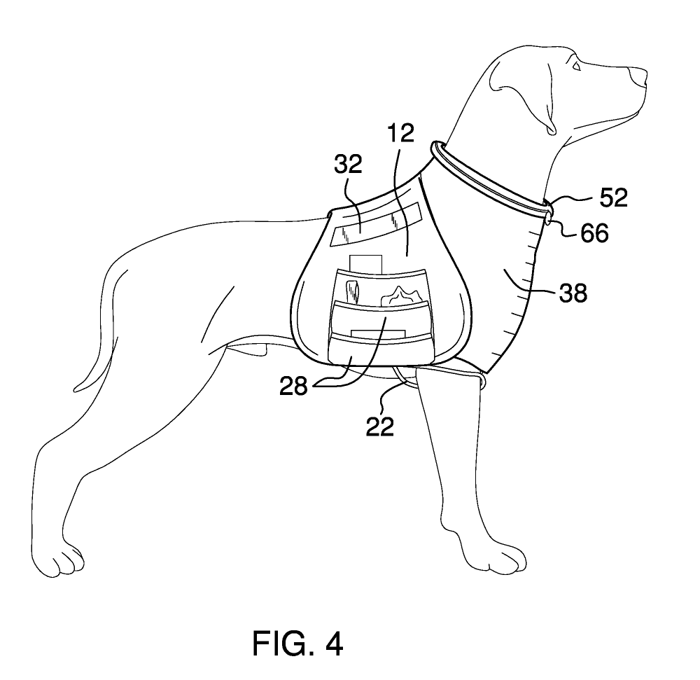

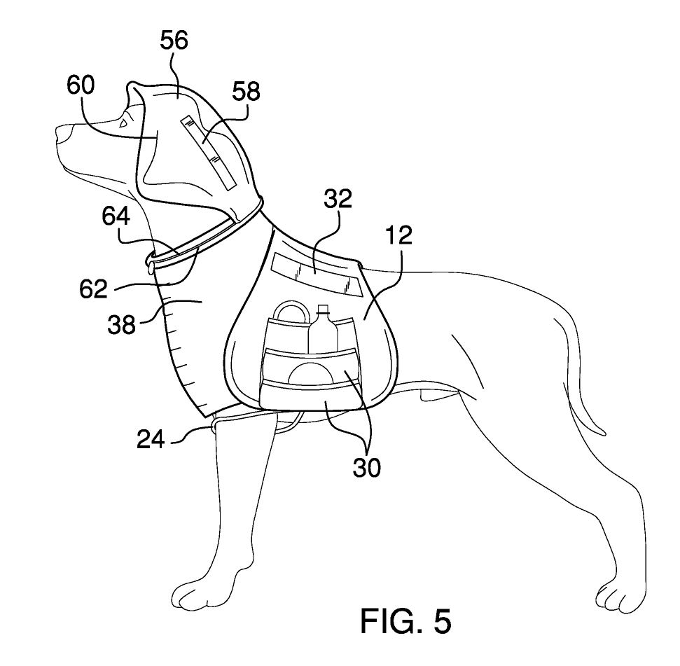

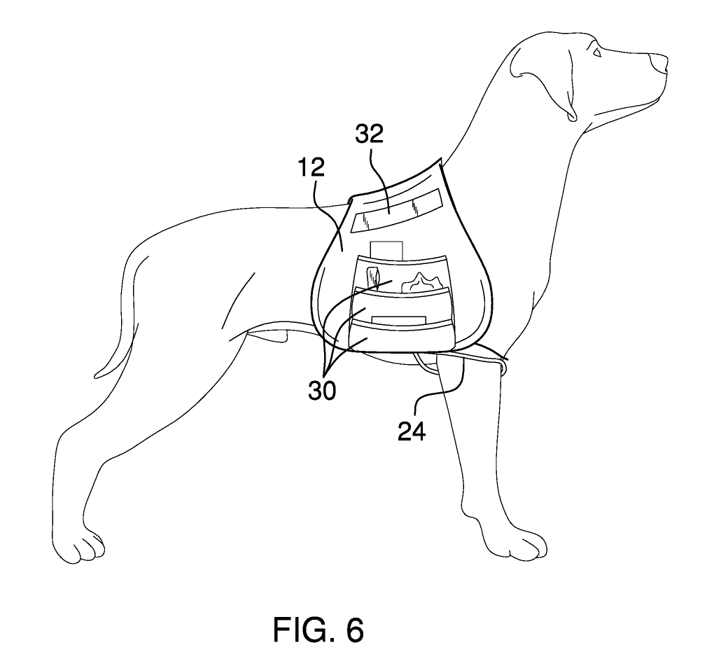

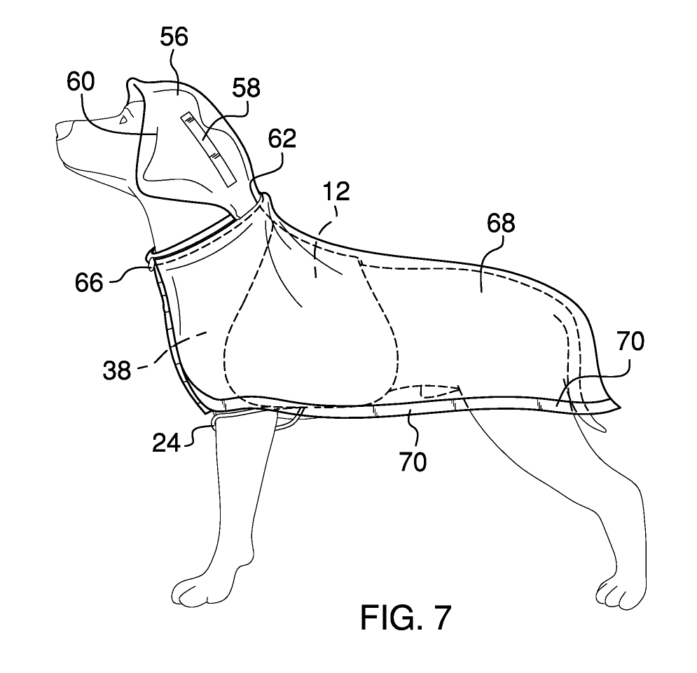

With reference now to the drawings, and in particular to FIGS. 1 through 7 thereof, a new canine saddlebag assembly embodying the principles and concepts of an embodiment of the disclosure and generally designated by the reference numeral 10 will be described.

As best illustrated in FIGS. 1 through 7, the canine saddlebag and rain gear assembly 10 generally comprises a first panel 12 that is configured to position over front shoulders of a dog and to couple to front legs of the dog. The first panel 12 is flexible. In one embodiment, the first panel 12 is water resistant. In another embodiment, the first panel 12 is substantially rectangularly shaped and defines a front edge 14, a back edge 16, opposing side edges 18 and corners 20 of the first panel 12. In yet another embodiment, the front edge 14 and the back edge 16 are concavely arcuate. In still yet another embodiment, the corners 20 are rounded.

A pair of couplers 22 is coupled to the first panel 12. Each coupler 22 is configured to couple to a respective front leg of the dog. The couplers 22 are configured to couple the first panel 12 to the dog. In one embodiment, each of the pair of couplers 22 comprises a pair of straps 24 that is coupled to and extends from a lower face 26 of the first panel 12. The pair of straps 24 is configured to position around the respective front leg of the dog to position the pair of straps 24 to be knotted to couple the first panel 12 to the dog.

A plurality of second panels 28 is coupled to the first panel 12 and defines a plurality of pockets 30. The pockets 30 are configured to stow items. In one embodiment, the plurality of pockets 30 comprises six pockets 30. The pockets 30 are positioned three each proximate to the opposing side edges 18 of the first panel 12. The second panels 28 are flexible. In another embodiment, the second panels 28 are water resistant.

A pair of first strips 32 is coupled to an upper face 34 of the first panel 12. The first strips 32 are reflective. The first strips 32 are configured to reflect the light that impinges on the first strips 32. Visibility of the dog to persons proximate to the dog is enhanced. In one embodiment, each first strip 32 is positioned between a center 36 and a respective opposing side edge 18 of the first panel 12.

A third panel 38 is reversibly couplable to the front edge 14 of the first panel 12. The third panel 38 has a first edge 40 that is complementary to the front edge 14 of the first panel 12. The first edge 40 is reversibly couplable to the front edge 14 of the first panel 12. The third panel 38 has a second edge 42 that is opposingly positioned to the first edge 40. In one embodiment, the second edge 42 is convexly arcuate. The third panel 38 is flexible. In another embodiment, the third panel 38 is water resistant.

A first connector 44 is coupled to the first panel 12 proximate to the front edge 14. A second connector 46 is coupled to the third panel 38 proximate to the first edge 40. The second connector 46 is complementary to the first connector 44. The second connector 46 is positioned to couple to the first connector 44 to reversibly couple the third panel 38 to the first panel 12. In one embodiment, the first connector 44 and the second connector 46 comprise a hook and loop fastener 48.

A hole 50 is positioned in the third panel 38. The hole 50 is configured to insert a head of the dog such that the third panel 38 is positioned over a chest of the dog. In one embodiment, the hole 50 is substantially circularly shaped.

A sleeve 52 is coupled to the third panel 38 proximate to the hole 50. In one embodiment, the sleeve 52 extends substantially around a perimeter 54 of the hole 50. A hat 56 is positioned in the sleeve 52. The hat 56 is reversibly extendable from the sleeve 52. The hat 56 is configured to cover the head of the dog. The hat 56 is flexible. In one embodiment, the hat 56 is water resistant.

A pair of second strips 58 is coupled to the hat 56. The second strips 58 are reflective. The second strips 58 are configured to reflect the light that impinges on the second strips 58. The visibility of the dog to the persons proximate to the dog is enhanced. In one embodiment, the second strips 58 are positioned singly on opposing faces 60 of the hat 56 such that the second strips 58 are positioned over opposing sides of the head of the dog.

A slit 62 is positioned longitudinally in the sleeve 52. A closure 64 is coupled to the sleeve 52 and is positioned adjacent to the slit 62. The closure 64 is configured to reversibly open and close the slit 62. The closure 64 is configured to be opened to deploy the hat 56. The closure 64 is configured to be closed to stow the hat 56 in the sleeve 52. In one embodiment, the closure 64 comprises a zipper 66.

A cape 68 is positioned in the sleeve 52. The cape 68 is reversibly extendable from the sleeve 52. The cape 68 is configured to extend along a back of the dog to substantially cover the first panel 12 and a torso of the dog. The cape 68 is water resistant.

A third strip 70 is coupled to the cape 68 proximate to a circumference 72 of the cape 68. The third strip 70 is reflective. The third strip 70 is configured to reflect the light that impinges on the third strip 70. The visibility of the dog to the persons proximate to the dog is enhanced.

In use, the first panel 12 is configured to position over front shoulders of the dog such that the pockets 30 are configured to stow items. The second connector 46 is positioned to couple to the first connector 44 to reversibly couple the third panel 38 to the first panel 12. The hole 50 is configured to insert the head of the dog such that the third panel 38 is positioned over the chest of the dog. Each pair of straps 24 is configured to position around the respective front leg of the dog to position the pair of straps 24 to be knotted to couple the first panel 12 to the dog. The hat 56 is extendable from the sleeve 52 and is configured to cover the head of the dog. The cape 68 is configured to extend along the back of the dog to substantially cover the first panel 12 and the torso of the dog. The first strips 32, the second strips 58 and the third strip 70 are configured to reflect the light that impinges on the first strips 32, the second strips 58 and the third strip 70. The visibility of the dog to the persons proximate to the dog is enhanced.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A canine saddlebag and rain gear assembly comprising:
a first panel configured for positioning over front shoulders of a dog and for coupling to front legs of the dog;
a plurality of second panels coupled to said first panel defining a plurality of pockets;
a third panel reversibly couplable to a front edge of said first panel;
a hole positioned in said third panel;
a sleeve coupled to said third panel proximate to said hole;
a hat positioned in said sleeve, said hat being reversibly extendable from said sleeve such that said hat is configured for covering the head of the dog; and
wherein said pockets are positioned on said first panel such that said pockets are configured for stowing items, wherein said hole is positioned in said third panel such that said hole is configured for inserting a head of the dog such that said third panel is positioned over a chest of the dog such that said hat is extendable from said sleeve such that said hat is configured for covering the head of the dog.

2. The assembly of claim 1, further including said first panel, said second panels, said third panel and said hat being flexible, said first panel, said second panels, said third panel and said hat being water resistant.

3. The assembly of claim 1, further including said first panel being substantially rectangularly shaped defining said front edge, a back edge, opposing side edges and corners of said first panel, said front edge and said back edge being concavely arcuate, said corners being rounded.

4. The assembly of claim 1, further including a pair of couplers coupled to said first panel, each said coupler being configured for coupling to a respective front leg of the dog, wherein said couplers are positioned on said first panel such that said couplers are configured for coupling said first panel to the dog.

5. The assembly of claim 4, further including each of said pair of couplers comprising a pair of straps coupled to and extending from a lower face of said first panel, wherein each said pair of straps is positioned on said first panel such that said pair of straps is configured for positioning around a respective front leg of the dog positioning said pair of straps for knotting for coupling said first panel to the dog.

6. The assembly of claim 1, further including said plurality of pockets comprising six said pockets, said pockets being positioned three each proximate to said opposing side edges of said first panel.

7. The assembly of claim 3, further including a pair of first strips coupled to an upper face of said first panel, said first strips being reflective, wherein said first strips are positioned on said first panel such that said first strips are configured for reflecting light impinging on said first strips such that visibility of the dog to persons proximate to the dog is enhanced, each said first strip being positioned between a center and a respective said opposing side edge of said first panel.

8. The assembly of claim 3, further including said third panel having a first edge, said first edge being complementary to said front edge of said first panel, said first edge being reversibly couplable to said front edge of said first panel, said third panel have a second edge opposingly positioned to said first edge, said second edge being convexly arcuate.

9. The assembly of claim 8, further comprising:
a first connector coupled to said first panel proximate to said front edge;
a second connector coupled to said third panel proximate to said first edge, said second connector being complementary to said first connector; and
wherein said second connector is positioned on said third panel such that said second connector is positioned for coupling to said first connector to reversibly couple said third panel to said first panel.

10. The assembly of claim 9, further including said first connector and said second connector comprising a hook and loop fastener.

11. The assembly of claim 1, further including said hole being substantially circularly shaped.

12. The assembly of claim 1, further including said sleeve extending substantially around a perimeter of said hole.

13. The assembly of claim 1, further including a pair of second strips coupled to said hat, said second strips being reflective, wherein said second strips are positioned on said hat such that said second strips are configured for reflecting light impinging on said second strips such that the visibility of the dog to persons proximate to the dog is enhanced, said second strips being positioned singly on opposing faces of said hat such that said second strips are positioned over opposing sides of the head of the dog.

14. The assembly of claim 1, further comprising:
a slit positioned longitudinally in said sleeve;
a closure coupled to said sleeve and positioned adjacent to said slit, said closure being configured for reversibly opening and closing said slit, wherein said closure is positioned on said sleeve such that said closure is configured for opening for deploying said hat and wherein said closure is configured for closing for stowing said hat in said sleeve;
a cape positioned in said sleeve, said cape being reversibly extendable from said sleeve; and
wherein said cape is configured for extending along a back of the dog for substantially covering said first panel and a torso of the dog, said cape being water resistant.

15. The assembly of claim 14, further including said closure comprising a zipper.

16. The assembly of claim 14, further including a third strip coupled to said cape proximate to a circumference of said cape, said third strip being reflective, wherein said third strip is positioned on said cape such that said third strip is configured for reflecting light impinging on said third strip such that the visibility of the dog to persons proximate to the dog is enhanced.

17. A canine saddlebag and rain gear assembly comprising:
a first panel configured for positioning over front shoulders of a dog and for coupling to front legs of the dog, said first panel being flexible, said first panel being water resistant, said first panel being substantially rectangularly shaped defining a front edge, a back edge, opposing side edges and corners of said first panel, said front edge and said back edge being concavely arcuate, said corners being rounded;
a pair of couplers coupled to said first panel, each said coupler being configured for coupling to a respective front leg of the dog, wherein said couplers are positioned on said first panel such that said couplers are configured for coupling said first panel to the dog, each of said pair of couplers comprising a pair of straps coupled to and extending from a lower face of said first panel, wherein each said pair of straps is positioned on said first panel such that said pair of straps is configured for positioning around a respective front leg of the dog positioning said pair of straps for knotting for coupling said first panel to the dog;
a plurality of second panels coupled to said first panel defining a plurality of pockets, wherein said pockets are positioned on said first panel such that said pockets are configured for stowing items, said plurality of pockets comprising six said pockets, said pockets being positioned three each proximate to said opposing side edges of said first panel, said second panels being flexible, said second panels being water resistant;
a pair of first strips coupled to an upper face of said first panel, said first strips being reflective, wherein said first strips are positioned on said first panel such that said first strips are configured for reflecting light impinging on said first strips such that visibility of the dog to persons proximate to the dog is enhanced, each said first strip being positioned between a center and a respective said opposing side edge of said first panel;
a third panel reversibly couplable to said front edge of said first panel, said third panel having a first edge, said first edge being complementary to said front edge of said first panel, said first edge being reversibly couplable to said front edge of said first panel, said third panel have a second edge opposingly positioned to said first edge, said second edge being convexly arcuate, said third panel being flexible, said third panel being water resistant;
a first connector coupled to said first panel proximate to said front edge;
a second connector coupled to said third panel proximate to said first edge, said second connector being complementary to said first connector, wherein said second connector is positioned on said third panel such that said second connector is positioned for coupling to said first connector to reversibly couple said third panel to said first panel, said first connector and said second connector comprising a hook and loop fastener;
a hole positioned in said third panel, wherein said hole is positioned in said third panel such that said hole is configured for inserting a head of the dog such that said third panel is positioned over a chest of the dog, said hole being substantially circularly shaped;
a sleeve coupled to said third panel proximate to said hole, said sleeve extending substantially around a perimeter of said hole;
a hat positioned in said sleeve, said hat being reversibly extendable from said sleeve such that said hat is configured for covering the head of the dog, said hat being flexible, said hat being water resistant;
a pair of second strips coupled to said hat, said second strips being reflective, wherein said second strips are positioned on said hat such that said second strips are configured for reflecting light impinging on said second strips such that the visibility of the dog to persons proximate to the dog is enhanced, said second strips being positioned singly on opposing faces of said hat such that said second strips are positioned over opposing sides of the head of the dog;
a slit positioned longitudinally in said sleeve;
a closure coupled to said sleeve and positioned adjacent to said slit, said closure being configured for reversibly opening and closing said slit, wherein said closure is positioned on said sleeve such that said closure is configured for opening for deploying said hat and wherein said closure is configured for closing for stowing said hat in said sleeve, said closure comprising a zipper;
a cape positioned in said sleeve, said cape being reversibly extendable from said sleeve such that said cape is configured for extending along a back of the dog for substantially covering said first panel and a torso of the dog, said cape being water resistant;
a third strip coupled to said cape proximate to a circumference of said cape, said third strip being reflective, wherein said third strip is positioned on said cape such that said third strip is configured for reflecting light impinging on said third strip such that the visibility of the dog to persons proximate to the dog is enhanced; and
wherein said pockets are positioned on said first panel such that said pockets are configured for stowing items, wherein said second connector is positioned on said third panel such that said second connector is positioned for coupling to said first connector to reversibly couple said third panel to said first panel, wherein said hole is positioned in said third panel such that said hole is configured for inserting the head of the dog such that said third panel is positioned over the chest of the dog, wherein each said pair of straps is positioned on said first panel such that said pair of straps is configured for positioning around the respective front leg of the dog positioning said pair of straps for knotting for coupling said first panel to the dog, such that said hat is extendable from said sleeve such that said hat is configured for covering the head of the dog, wherein said cape is configured for extending along the back of the dog for substantially covering said first panel and the torso of the dog, wherein said first strips are positioned on said first panel, wherein said second strips are positioned on said hat and wherein said third strip is positioned on said cape such that said first strips, said second strips and said third strip are configured for reflecting the light impinging on said first strips, said second strips and said third strip such that the visibility of the dog to the persons proximate to the dog is enhanced.
